(19) United States
(12) Patent Application Publication
(10) Pub. No.: US 2002/0182292 A1
(43) Pub. Date: Dec. 5, 2002

(54) Soda bottle confectionery

(76) Inventor: Brad Baker, Colorado Springs, CO (US)

Correspondence Address: PEACOCK MYERS AND ADAMS P C, P O BOX 26927, ALBUQUERQUE, NM, 871256927

(21) Appl. No.: 10/072,179

(22) Filed: Feb. 5, 2002

Related U.S. Application Data
(63) Continuation-in-part of application No. 09/874,440, filed on Jun. 4, 2001.

(51) Int. Cl. A23B 4/00

(52) U.S. Cl. 426/112

(57) ABSTRACT

A confectionery in the shape of a soda pop bottle having a top portion, a lower portion, a flowable confectionery disposed within the lower portion, and a hard candy or coatable item extending from the upper portion into the lower portion to dip into the flowable confectionery.

### CROSS-REFERENCE TO RELATED APPLICATIONS

This application is a continuation-in-part application of U.S. patent application Ser. No. 09/874,440, entitled “Soda Bottle Confectionery”, to Sciarini, filed on Jun. 4, 2001, and the specification thereof is incorporated herein by reference.

This application is related to U.S. Utility Patent Applications entitled; “Confectionery With Body, Handle and Container,” Attorney Docket No. 30687-11; “Soda Bottle Confectionery With Open Top,” Attorney Docket No. 30687-18; and “Self-Sealing Cap,” Attorney Docket No. 30687-19; and to U.S. Design Patent Applications entitled “Alien Head for Confectionery Product,” Attorney Docket No. 30687-12; “Alien Head for Confectionery Product,” Attorney Docket No. 30687-13; “Alien Head for Confectionery Product,” Attorney Docket No. 30687-14; “Alien Head for Confectionery Product,” Attorney Docket No. 30687-15; and “Alien Body for Confectionery Product,” Attorney Docket No. 30687-16, all of which are filed concurrently on even date herewith, and the specifications and drawings thereof are incorporated herein by reference.

### COPYRIGHTED MATERIAL

A portion of the disclosure of this patent document and of the related applications listed above contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

1. Field of the Invention (Technical Field)

The present invention relates to a soda bottle shaped confectionery.

2. Background Art

The confectionery industry uses a variety of tools or utensils to facilitate extraction of a candy material from a reservoir. For instance, the following design patents disclose candy dipping tools: U.S. Pat. No. Des. 264,298, entitled “Candy Dipping Tool,” to Guttman, issued May 11, 1982, discloses a candy dipping tool with an elongated handle and a loop end; U.S. Pat. No. Des. 264,169, entitled “Candy Dipping Tool,” to Guttman, issued May 4, 1982, discloses a candy dipping tool having an elongated handle and a forked end comprising two prongs; and U.S. Pat. No. Des. 264,038, entitled “Candy Dipping Tool,” to Guttman, issued Apr. 27, 1982, discloses a candy dipping tool having an elongated handle and a spiral end for candy dipping. Another patent, U.S. Pat. No. 2,281,267, entitled “Eating Utensil,” to Chapman, issued Apr. 28, 1942, discloses eating utensils wherein the food-holding portion of the eating utensil contains a layer of edible flavored material.

The dipping of a foodstuff directly into another foodstuff is relatively common practice in food manufacturing, food service, and amongst consumers in general. The following patents disclose matter germane to these practices:

U.S. Pat. No. 5,676,990, entitled “Method of Food Article Dipping and Whipping in a Condiment Container,” to Wawrzynski, issued Oct. 14, 1997, discloses a method for removing excess condiment from a food article. The method has three steps: manipulating, inserting and removing. In the first step, manipulating, a slit is formed in a container containing the condiment. In the next step, inserting, the food article is inserted through the slit into the condiment container. The final step entails removing the food article from the container. As the food article is removed from the container, excess condiment is stripped off the food article as it passes through the slit.

U.S. Pat. No. 3,312,555, entitled “Handle-Anchored Formed Sugar Block and Method of Producing Same,” to Rossi et al., issued Apr. 4, 1967, discloses a handle-anchored formed sugar block for stirring a beverage in a container. The purpose of the apparatus is to sugar-sweeten beverages.

U.S. Pat. No. 1,718,997 entitled “Frozen Confection,” to Burt, issued Jul. 2, 1929, discloses a frozen confection substantially in the shape of a rectangular block attached to a stick handle. The confection may contain an edible shell composed of any suitable material such as chocolate, which will provide a relatively hard outer surface at normal temperatures. When chocolate is used, the frozen body portion is preferably dipped in the heated chocolate in substantially the same way that other candies and confections are dipped.

U.S. Pat. No. 5,370,884, entitled “Combination Sucker and Edible Powder,” to Coleman, issued Dec. 6, 1994, discloses a confectionery apparatus having a top plastic cap for housing a hard candy sucker and a lower plastic container for housing a powder or granular candy. After removing the top cap, the hard candy is moistened and then dipped into the powder or granular candy. A similar product is marketed by The Topps Company, Inc., under the name “Baby Bottle Pop™”.

U.S. Pat. No. 3,840,678, entitled “Edible Spooning Device,” to Price, issued Oct. 8, 1974, discloses an edible product having food receiving cavities for spooning and consuming foodstuff.

Confectioneries having a shape of a non-edible are disclosed in the following patents: U.S. Pat. No. Des. 269,559, entitled “Confection on a Stick,” to Sellares, issued Jul. 5, 1983, discloses a confection on a stick shaped in the form a fist with an extended index finger; U.S. Pat, No. Des. 260,045, entitled “Frozen Confection or Similar Article,” to Frankel et al., issued Aug. 4, 1981, discloses a frozen confection or similar article that is in the shape of a foot; U.S. Pat. No. Des. 177,206, entitled “Confection,” to Babcock, issued Mar. 27, 1956, discloses a tube piece confection shaped substantially like a spoon wherein the spoon end portion comprises a confection; U.S. Pat. No. Des. 92,473, entitled “Lollipop or Similar Article,” to Keller, issued Jun. 12, 1934, discloses a lollipop or similar article in the shape of a mug with over-flowing froth; U.S. Pat. No. Des. 62,611, entitled “Hard Candy Confection,” to Hochstraser, issued Jul. 3, 1923, discloses a hard candy confection having the shape of a face; and U.S. Pat. No. 16,030, entitled “Candy or Confection,” to Schwarzschild and Greenfield, issued Apr. 7, 1885, discloses a candy or confectionery in the shape of a broom wherein both the whisk and handle portion comprise the confectionery.

Food products, comprising multiple foodstuffs, having at least one discrete compartment that allows for or facilitates mixing are disclosed in the following patents:

U.S. Pat. No. 3,413,128, entitled “Bottle,” to Steinbarth et al., issued Nov. 26, 1968, discloses a bottle having two container portions. One container is designed to hold a liquid, such as an alcoholic beverage, while the other container is designed to hold a granular solid, such as salt.

U.S. Pat. No. 1,889,882, entitled “Container for Food Products,” to Woods, issued Dec. 6, 1932, discloses a container for food products that has at least two sections. The sections hold different food products and can be opened to allow co-mingling of the different food products.

U.S. Pat. No. 1,983,685, entitled “Receptacle for Food Products,” to Townsley, issued Dec. 11, 1934, discloses a receptacle for holding food products having a main bag portion and an auxiliary compartment. The auxiliary compartment is designed to contain a dry flavoring material. The auxiliary compartment may be opened such that the material contained within that compartment mixes with the material in the main bag portion.

U.S. Pat. No. 2,647,681, entitled “Seasoning Dispenser,” to Paoli, issued Aug. 4, 1953, discloses a package for bulk food such as potatoes or popcorn having a separate compartment for seasoning.

U.S. Pat. No. 2,824,010, entitled “Flavor-Containing Milk Container Top,” to Pedersen, issued Feb. 18, 1958, discloses a flavor-containing milk container top that affixes to a glass milk bottle, plastic milk bottle, or a carton milk container. The flavoring ingredients are released from the receptacle in the milk container top such that they mix with the milk.

Non-food products, having multiple components, having at least one discrete compartment that allows for or facilitates mixing are disclosed in the following patents:

U.S. Pat. No. 2,832,981, entitled “Device for Applying Liquid Adhesive or the Like,” to Breuhan, issued May 6, 1958, discloses a flexible-bodied container for liquid adhesive paint. The device also has a brush that can be in either an inverted or extended position. In the extended position, liquid from the container flows through the bristles of the brush for application. In the inverted position, the brush is in contact with the liquid in the container or the gaseous environment created by the liquid in the container such that the bristles do not harden.

U.S. Pat. No. 3,386,792, entitled “Paint Kit,” to Ireland, issued Jun. 4, 1968, discloses a device with a paintbrush and an integral container for paint. The paint container is housed in the end one end of the device while the paintbrush is positioned at the other end.

None of these references disclose a confectionery in the shape of a soda bottle wherein the top attaches to the bottom, and a candy extends into the bottom into a flowable confectionery.

### SUMMARY OF THE INVENTION (DISCLOSURE OF THE INVENTION)

The present invention is of a confectionery comprising: a bottle shaped container comprising an upper portion and a lower portion, the upper and lower portions removeably attachable to each other; and the upper portion including a solid edible candy disposed thereon extending downward from the upper portion into the lower portion when the upper and lower portions are attached. In the preferred embodiment, the upper portion comprises a top half of the bottle shaped container and the top half includes an integral cap. The lower portion comprises a bottom of the bottle shape. The upper portion further comprises an insert for attachment of the stem, wherein the insert is removeably insertable into the upper portion. A lower edge of the upper portion engages with an upper edge of the lower portion for releasable attachment of the upper portion to the lower portion. The upper portion attaches to the lower portion by twisting, wherein at least one of the upper portion and the lower portion comprise a correlating set of ridges and grooves or a set of mating twist attachment elements. The confectionery set preferably further comprises corresponding notches. The lower portion further includes a flowable confectionery therein, wherein the edible candy is when wetted is coatable when dipped into the flowable confectionery and extractable from the lower portion. The flowable confectionery comprises at least one of sugar-based and artificial sweetener-based confectionery, such as sugar, organic acid, flavor agent, color agent, and/or flow agent. The flow agent comprises at least one of powdered cellulose, magnesium stearate, stearic acid, paraffin and microcrystalline waxes, polyethylene waxes, mineral and other lubricating oils, talc, silicone dioxide, lactose, and calcium citrate. In alternative embodiments, the flowable confectionery comprises a luminiferous confectionery, gas-generating or gas-releasing confectionery, or a fluid (preferably having viscoelastic Theological properties). At least one of the upper and lower portions comprises a rigid material, such as plastic, glass, wood, and metal. The edible candy preferably comprises at least one of sugar, corn syrup, water, flavor agent and color agent.

The present invention is also of a confectionery comprising: a bottle shaped container comprising an upper reservoir and a lower reservoir, the upper and lower reservoirs releasably attachable to each other; the upper reservoir including a stem and an edible candy disposed thereon extending downward from the upper reservoir into the lower portion; and wherein the lower reservoir includes a flowable confectionery. In the preferred embodiment, at least one of the upper and lower reservoirs comprises a set of mating twist attachment elements.

The present invention is additionally of a confectionery comprising: a bottle shaped plastic container comprising a top half and a bottom half, the top half selectively releasably connected to the bottom half; the top half including a stem and a hard candy molded on the stem and extending down into the bottom half; and a flowable confectionery disposed within the bottom half; whereby the hard candy may be wetted, dipped into the flowable confectionery and coated so as to extract the flowable confectionery for consumption. In the preferred embodiment, the upper portion and the lower portion twist relative to each other for twist attachment. At least one of the upper portion and the lower portion comprise a set of ridges and grooves for twist attachment.

The present invention is still further of a confectionery set comprising: a bottle shape comprising an upper portion and a lower portion, the upper and lower portions removeably attachable to each other; and the upper portion comprising a stem and an edible candy disposed thereon extending downward from the upper portion in the lower portion. In the preferred embodiment, the upper portion comprises a top of the bottle shape and the top comprises an integral cap. The lower portion comprises a bottom of the bottle shape. The upper portion further comprises an insert for attachment of the stem, wherein the insert is removeably insertable into the upper portion. A perimeter of the upper portion engages with a perimeter of the lower portion for attachment of the upper portion to the lower portion. The upper portion attaches to the lower portion by twisting, wherein at least one of the upper portion and the lower portion comprise a correlating set of ridges and grooves. The confectionery set preferably further comprises corresponding notches. The lower portion further comprises a flowable confectionery disposed therein, wherein the edible candy is coatable by the flowable confectionery and extractable by the coatable body portion. he flowable confectionery comprises at least one of sugar-based and artificial sweetener-based confectionery, such as sugar, organic acid, flavor agent, color agent, and/or flow agent. The flow agent comprises at least one of powdered cellulose, magnesium stearate, stearic acid, paraffin and microcrystalline waxes, polyethylene waxes, mineral and other lubricating oils, talc, silicone dioxide, lactose, and calcium citrate. In alternative embodiments, the flowable confectionery comprises a luminiferous confectionery, gas-generating or gas-releasing confectionery, or a fluid (preferably having viscoelastic rheological properties). At least one of the upper and lower portions comprises a rigid material, such as plastic, glass, wood, and metal. The edible candy preferably comprises at least one of sugar, corn syrup, water, flavor agent and color agent.

The invention is also of a confectionery set comprising: a bottle shape comprising an upper portion and a lower portion, the upper and lower portions removeably attachable to each other; the upper portion comprising a stem and an edible candy disposed thereon extending downward from the upper portion in the lower portion; and wherein the upper portion and the lower portion twist relative to each other for twist attachment. In the preferred embodiment, a flowable confectionery is disposed within the container. At least one of the upper portion and the lower portion comprise a set of ridges and grooves for twist attachment.

The invention is additionally of a confectionery set comprising: a bottle shape comprising an upper portion and a lower portion, the upper and lower portions removeably attachable to each other; the upper portion comprising a stem and an item disposed thereon extending downward from the upper portion into the lower portion; and a flowable confectionery disposed within the lower portion. The item may be edible or non-edible. In the preferred embodiment, the upper portion and the lower portion twist relative to each other for twist attachment. At least one of the upper portion and the lower portion comprise a set of ridges and grooves for twist attachment.

The present invention is still further a confectionery comprising: a bottle shaped container comprising an upper portion and a lower portion, wherein the upper and lower portions are removeably attachable to each other; the upper portion includes a solid edible candy disposed thereon extending downward from the upper portion into the lower portion when the upper and lower portions are attached; and the upper portion attaches to the lower portion by twisting. At least one of the upper and lower portions may comprise a set of mating twist attachment elements comprising at least two correlating sets of ridges and grooves. The twist attachment elements may further comprise corresponding notches.

The lower portion may include a flowable confectionery therein. The confectionery may comprise an edible candy that when wetted is coatable when dipped into the flowable confectionery and extractable from the lower portion. The flowable confectionery may be comprised of a member selected from the group consisting of sugar-based and artificial sweetener-based confectionery, which may include sugar, organic acid, flavor agent, color agent, and flow agent. The confectionery may additionally comprise a luminiferous confectionery or gas-generating and gas-releasing confectionery. The flowable confectionery may comprise a fluid. Such a fluid may comprise viscoelastic rheological properties. At least one of the upper and lower portions may comprise a rigid material which may be at least one material selected from the group consisting of plastic, glass, wood, and metal.

The present invention is further a confectionery set comprising: a bottle shape comprising an upper portion and a lower portion, wherein the upper and lower portions are removeably attachable to each other; the upper portion comprises at least one stem and an item disposed thereon extending downward from the upper portion into the lower portion; and a flowable confectionery disposed within the lower portion. The stem may comprise a cylindrical or a rectangular body. The set may comprise more than one stem. Such stems may be arranged in an adjacent configuration. Stems may comprise at least one projection. Stems may further comprise sidewalls having apertures disposed therein or may comprise protruding sidewalls. Such protruding sidewalls may comprise channels disposed therebetween. The item of the set may be edible or non-edible.

A primary object of the present invention is to provide a confectionery product in the form of a soda pop bottle.

A primary advantage of the present invention is enhanced play value due to interactive features of the product.

Other objects, advantages and novel features, and further scope of applicability of the present invention will be set forth in part in the detailed description to follow; taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a side view of a preferred embodiment of the present invention showing the confectionery set in a closed position;

FIG. 2 is a side transparent view of the FIG. 1 embodiment in an open position;

FIG. 3 is a bottom view of the top portion of the FIG. 1 embodiment;

FIG. 4 is a side transparent view of the alternate embodiment in an open position showing multiple grooves and ridges;

FIG. 5 is a side view of an upper portion with a candy stem insert; and

FIG. 6 is a side view of an upper portion with an alternate embodiment of a candy stem insert.

### DESCRIPTION OF THE PREFERRED EMBODIMENTS (BEST MODES FOR CARRYING OUT THE INVENTION)

The present invention is a confectionery product in the shape of a soda pop bottle.

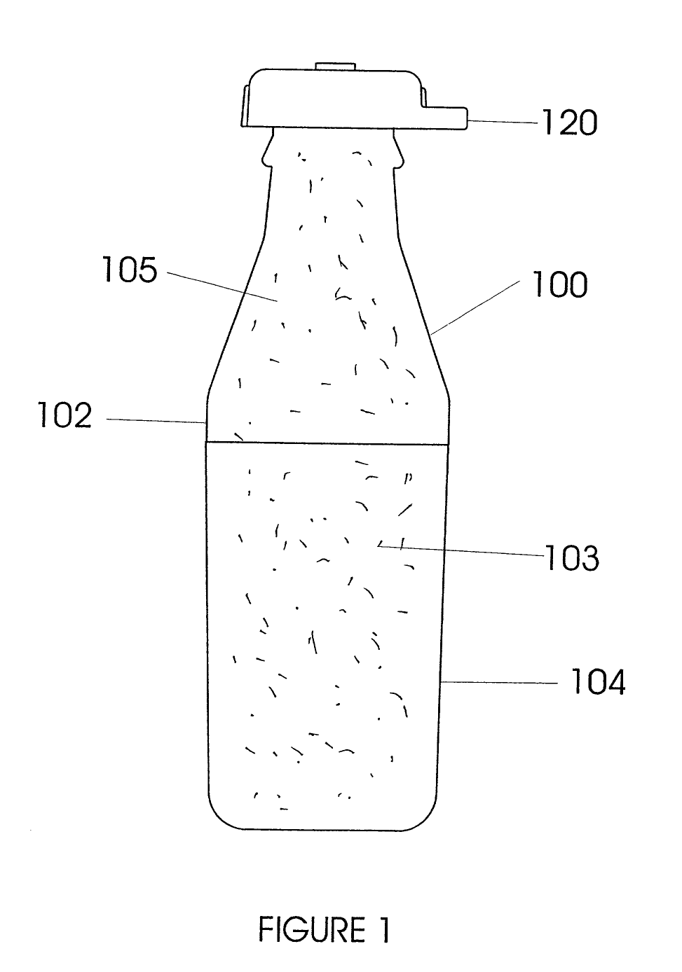

Several non-limiting embodiments of the container of the present invention are shown in the drawings. FIG. 1 is a side view of the preferred bottle-shaped container 100 of the present invention comprising an upper portion (also referred to as a reservoir) 102 and a lower portion (also referred to as a reservoir) 104. Bottle container 100 is attachable and separable at a juncture between upper portion 102 and lower portion 104. Lower portion 104 contains a flowable confectionery 103, preferably a powder or liquid. A hard confectionery is attached to upper portion 104 and extends into lower portion 104. The hard confectionery is then wetted (e.g., licked) and dipped into the flowable confectionery 103.

Bottle container 100 may further comprise a cap 120. In the preferred embodiment, cap 120 is integral to upper portion 102 and does not open upper portion. Cap 120 may be of any configuration, such as shown, or other types of caps, such as metal crimped, and the like.

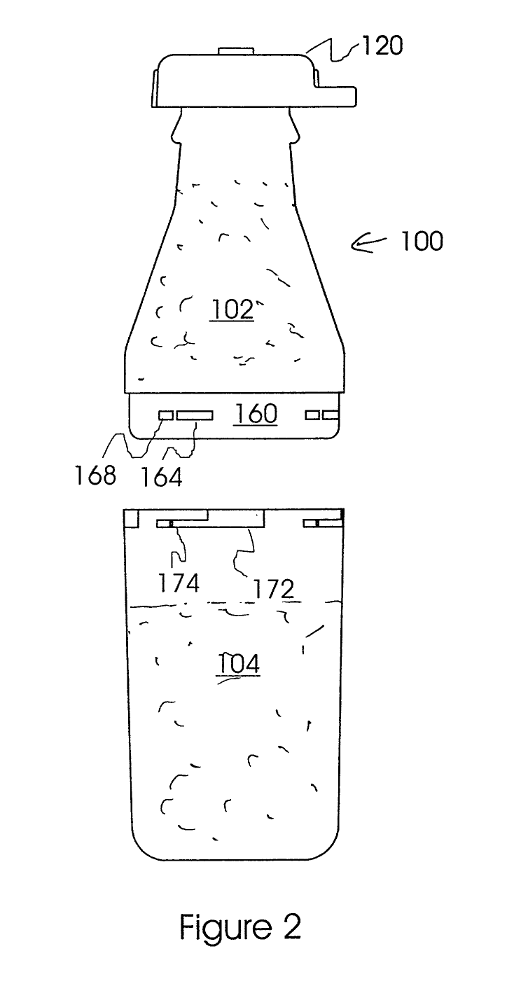

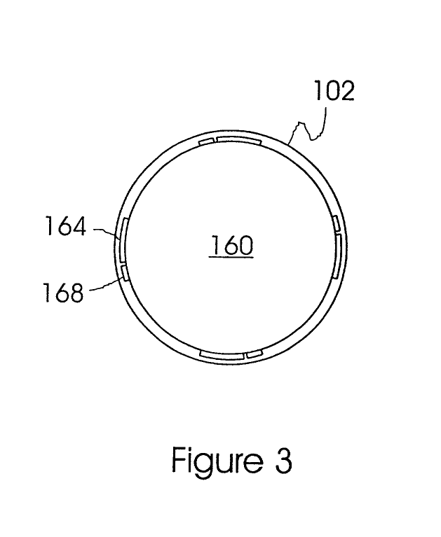

FIG. 2 shows a side view of container 100 in an open position (without stem and candy). A locking or flange mechanism 160 blocks upper and lower portions 102,104 together to form the soda bottle shape. A bottom view of flange mechanism 160 of upper portion 102 is shown in FIG. 3. As shown in FIGS. 2-3, locking mechanism 160 extends from upper portion 102 and is substantially matched to an inner diameter of lower portion 104. Insert 160 comprises a plurality of ridges: large ridges 164, 164′, 164, 164′″, and small ridges 168, 168′, 168″, 168′″. A notch or space 165 separates each large ridge 164 from each small ridge 168. Referring to FIG. 2, lower portion 104 comprises a plurality of grooves 172 for receiving ridges 164, 168 of upper portion 102. Each groove 172 further comprises a notch 173 and extended groove 174 that is cooperably positioned respectively with ridge 164, notch 165 and ridge 168 of upper portion 102. An approximate 30 degree to approximate 45 degree turn of lower portion 104 with respect to upper portion 102 sets ridge 168 of upper portion 102 into groove 173; ridge 164 into groove 172; and notch 165 into notch 173. Upper portion 102 and lower portion 104 are unlocked by a simple turn in the opposite direction.

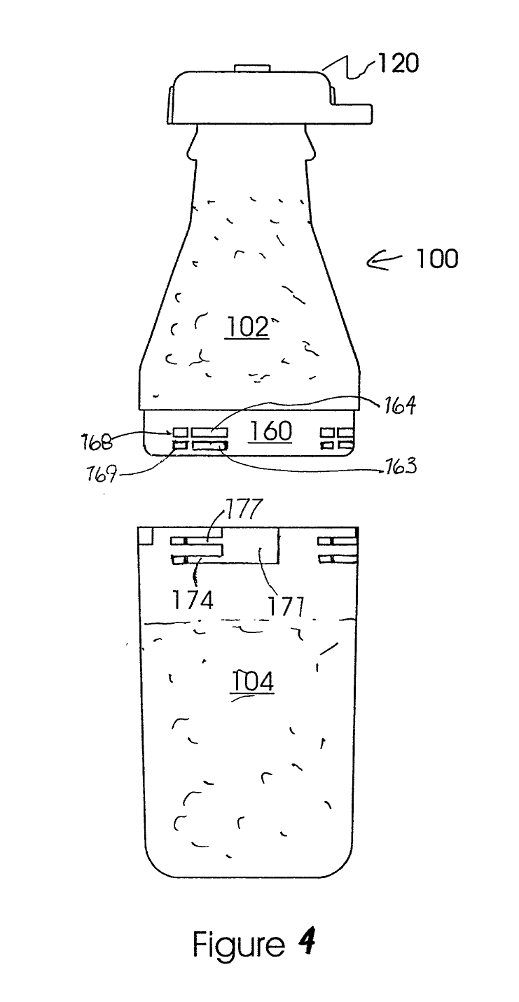

In an alternate embodiment as depicted in FIG. 4, two sets of large ridges 164,163 are position in parallel relation, and two sets of small ridges 168, 169 are additionally correspondingly placed. As a result, corresponding deep groove 171, with dual notches 173,175 and dual extended grooves 174, 177, are correspondingly positioned in parallel relation for receipt of dual large and small ridges 164,163,168, 169. This alternate embodiment is engaged for closure and release in the same manner as the preferred embodiment. In further alternate embodiments, additional grooves and corresponding notches may be utilized.

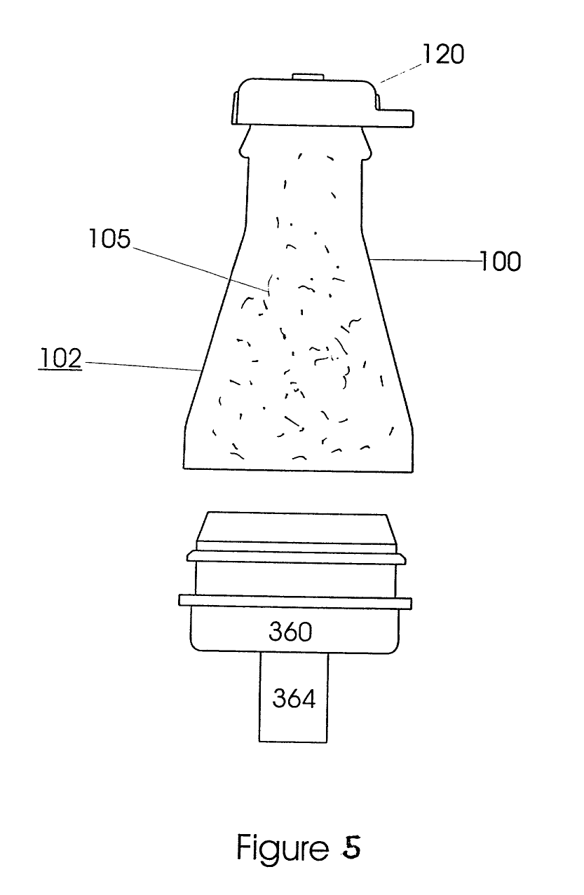

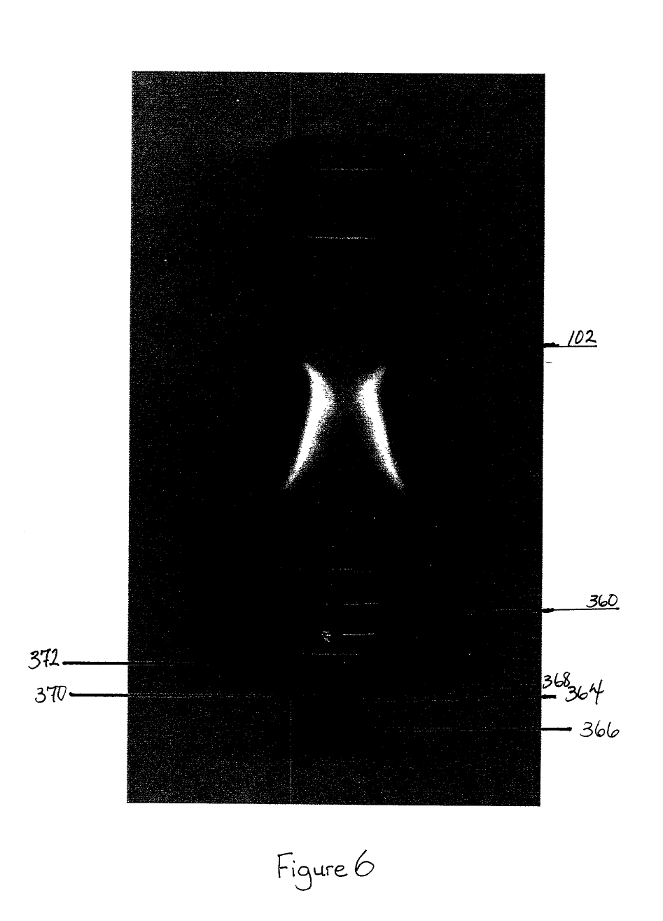

FIG. 5 is an expanded view of insert 360 with stem 364. This insert 360 fits into upper portion 102 of bottle shaped container 100 (the lower portion is not shown in FIG. 4). Insert 360 may be integral with or separable from upper portion 102. Stem 364 is used for attachment of a hard confectionery or coatable item (not shown) to dip into flowable confectionery 103. Stem 364 may comprise a single cylindrical or rectangular unit as depicted in FIG. 5, or it may comprise multiple stems or stem 364 having one or more projections 366 or protruding side walls 368 for receipt of the candy as depicted in FIG. 6. These alternate embodiments may comprise adjacent protruding side walls comprising channels 370 disposed between the side walls, or side walls comprising apertures 372 for receipt of candy. Any number of side walls or protrusions may be utilized, including one, and may extend from a central cylinder or rectangular stem. This hard confectionery or item may be of any shape. The item may be edible or non-edible. The item is preferably coatable so that it can be licked by a user and then dipped into flowable confectionery 103 disposed in lower portion 104, which then sticks to the item. The item is dipped into flowable confectionery 103 disposed within lower portion 104, either before or after the user licks the item. In the preferred embodiment, the item is preferably an edible and coatable candy. The candy can be molded into the desired shape.

Upper and lower portions portion 102, 104 are preferably made of a plastic material (e.g. injection or vacuum molded plastic), but can also be made of other materials, such as metal, glass, wood, and the like. Upper and lower portions 102, 104 should be of a material that is easily held and attached by a user. In that regard, upper and lower portions 102, 104 are preferably made of a rigid material.

Although a twist-type attachment is illustrated as the preferred closure in the drawings, the invention is not limited to this type of attachment. For example, upper portion 102 may be disposed on lower portion 104 by the following: screw-on attachment, molded lip/rim, snap on, clamp, form or friction fit, and the like. The invention is not limited to the particular twist attachment shown in the drawings.

In the preferred embodiment, as show in the drawings, upper portion 102 is attached to and directly above lower portion 104. Stem 364 extends from upper portion 102 and may be disposed within lower portion 104. Stem 364 cannot interfere with attachment of upper portion 102 to lower portion 104 and is therefore of a smaller diameter or width than upper and lower portions 102, 104.

The term “lower portion” as used throughout the specification and claims is intended to include a lower portion complimentary to upper portion. The examples shown in the drawings are of soda bottles or soda pop bottles that are cut in halves. However, the invention is not limited to soda bottles, but can be upper and lower portions of other bottles and items, e.g., a baseball bat. For instance, FIG. 5 is a bottle or baseball bat shape.

An alternative embodiment of the container is shown in FIG. 5.

Flowable confectionery 103 of the present invention comprises a flowable substance such as a liquid or a powder, or combination thereof. The confectionery is preferably a powder, and optionally may comprise a gas-generating, gas-releasing or “popping” type of powder. Confectionery 103 may also be a fluid or liquid, e.g. a viscous liquid.

Regarding the composition of confectioneries of the present invention, a hard candy portion (e.g., a candy attached to stem 364) is preferably manufactured from, for example:

Sugar (from between approximately 55% and approximately 75% by weight);

Corn syrup (from between approximately 20% and approximately 40% by weight);

Water (from between approximately 1% and approximately 5% by weight);

Flavor agent (from between approximately 0.1% to approximately 2% by weight); and

Color agent (from approximately less than 1% by weight).

A candy powder portion (e.g., flowable confectionery 103), is preferably manufactured from, for example:

Sugar (from approximately 90% to approximately 98% by weight);

Malic Acid (from approximately 1% to approximately 6% by weight);

Flavor Agent (from approximately 1% to approximately 5% by weight);

ColorAgent 9from approximately 0.1% to approximately 2% by weight); and

Flow Agent (from approximately 0.1% to approximately 5% by weight).

The flow agent comprises a substance that promotes flowability of the candy powder. Flow agents may comprise, but are not limited to, for example, powdered cellulose, magnesium stearate, stearic acid, paraffin and microcrystalline waxes, polyethylene waxes, mineral and other lubricating oils, talc, silicone dioxide, lactose, calcium citrate and the like. In general, flow agents reduce attractive and/or frictional forces between particles and/or absorb moisture. Flow agents are sometimes known as anti-caking agents and/or desiccating agents. Examples of useful flow agents include CAB-O-SIL® (Cabot Corporation, Boston, Mass.) and SYLOID® (W. R. Grace & Co., New York, N.Y.).

Alternatives are given below where a hard candy portion is manufactured from ingredients in the following possible ranges:

Sugar (from approximately 0% to approximately 95% by weight);

Corn Syrup (from approximately 0% to approximately 80% by weight);

Water (from approximately 0% to approximately 50% by weight);

Flavor Agent (from approximately 0% to approximately 20% by weight); and

Color Agent (from approximately 0% to approximately 10% by weight).

Likewise, a candy powder portion may be manufactured from ingredients in the following possible ranges:

Sugar (from approximately 0% to approximately 100% by weight);

Malic Acid (from approximately 0% to approximately 40% by weight);

Flavor Agent (from approximately 0% to approximately 20% by weight);

Color Agent (from approximately 0% to approximately 10% by weight); and

Flow Agent (from approximately 0% to approximately 5% by weight).

In an alternative embodiment, upper portion 102, lower portion 104, stem 364 or confectionery may be luminiferous in that they give off or transmit light. The term luminiferous encompasses, but is not limited to, luminescence, fluorescence, and phosphorescence. For example, a light source may be housed within upper portion 104, lower portion 104, insert 360 or stem 364. In such an embodiment of the present invention, a light source comprises, for example, but is not limited to, a light bulb or a light emitting diode. Power for driving the source comprises, for example, but is not limited to battery power, mechanical-to-electrical energy power, and/or solar-to-electrical energy power.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and such variation and modifications are covered in this disclosure to the extent that they are modifications and/or equivalents. The entire disclosures of all references, applications, patents, and publications cited above are hereby incorporated by reference. CLAIMS

What is claimed is:

1. A confectionery comprising:
a bottle shaped container comprising an upper portion and a lower portion, said upper and lower portions removeably attachable to each other;
said upper portion including a solid edible candy disposed thereon extending downward from said upper portion into said lower portion when said upper and lower portions are attached; and
wherein said upper portion attaches to said lower portion by twisting.

2. The confectionery of claim 1 wherein at least one of said upper and lower portions comprise a set of mating twist attachment elements comprising at least two correlating sets of ridges and grooves.

3. The confectionery of claim 2 further comprising corresponding notches.

4. The confectionery of claim 2 wherein said lower portion includes a flowable confectionery therein.

5. The confectionery of claim 4 wherein said edible candy when wetted is coatable when dipped into said flowable confectionery and extractable from said lower portion.

6. The confectionery of claim 4 wherein said flowable confectionery comprises at least one member selected from the group consisting of sugar-based and artificial sweetener-based confectionery.

7. The confectionery of claim 6 wherein said flowable confectionery comprises at least one member selected from the group consisting of sugar, organic acid, flavor agent, color agent, and flow agent.

8. The confectionery of claim 4 wherein said flowable confectionery comprises a luminiferous confectionery.

9. The confectionery of claim 4 wherein said flowable confectionery comprises at least one member selected from the group consisting of gas-generating and gas-releasing confectionery.

10. The confectionery of claim 4 wherein said flowable confectionery comprises a fluid.

11. The confectionery of claim 10 wherein said fluid comprises viscoelastic rheological properties.

12. The confectionery of claim 1 wherein at least one of said upper and lower portions comprises a rigid material.

13. The confectionery of claim 1 wherein at least one of said upper and lower portions comprises at least one material selected from the group consisting of plastic, glass, wood, and metal.

14. A confectionery set comprising:
a bottle shape comprising an upper portion and a lower portion, said upper and lower portions removeably attachable to each other;
said upper portion comprising at least one stem and an item disposed thereon extending downward from said upper portion into said lower portion; and
a flowable confectionery disposed within said lower portion.

15. The confectionery set of claim 14 wherein said stem comprises a cylindrical or a rectangular body.

16. The confectionery set of claim 14 comprising more than one stem.

17. The confectionery set of claim 16 wherein said stems in an adjacent configuration.

18. The confectionery set of claim 14 wherein said stem comprises at least one projection.

19. The confectionery set of claim 14 wherein said stem comprises sidewalls having apertures disposed within said sidewalls.

20. The confectionery set of claim 14 wherein said stem comprises protruding sidewalls.

21. The confectionery set of claim 20 wherein said protruding sidewalls comprise channels disposed between said side walls.

22. The confectionery set of claim 14 wherein said item is edible.

23. The confectionery set of claim 14 wherein said item is non-edible.
